(19) United States
(12) Patent Application Publication
(10) Pub. No.: US 2009/0089087 A1
(43) Pub. Date: Apr. 2, 2009

(54) Method for Developing and Marketing a Post Operative Home Recovery Kit for Use by a Patient After Discharge From a Hospital and for Recuperation At Home

(76) Inventor: Kevin Todd Kotecki, Burr Ridge, IL (US)

Correspondence Address: GREENBERG TRAURIG, LLP, 77 WEST WACKER DRIVE, SUITE 2500, CHICAGO, IL, 60601-1732, US

(21) Appl. No.: 12/094,587

(22) PCT Filed: Nov. 21, 2005
(86) PCT No.: PCT/US05/42431

§ 371 Date: May 21, 2008

(51) Int. Cl. G06Q 10/00; G06Q 50/00

(52) U.S. Cl. 705/2

(57) ABSTRACT

A surgical recovery kit, which contain various medical and related articles, which are specifically “tuned” to be used by individuals who are planning to undergo specific medical procedures. The kits are intended to be used by convalescent patients who are re-covering at home.

### BACKGROUND OF THE INVENTION

1. The Technical Field

The technical field of this invention relates to post-operative in-home recuperation of patients, in particular, kits for facilitating home recuperation.

2. Prior Art

In recent years, hospitals have had to deal with the rising costs of business operations and the fact that not all of the increased costs can be passed on the insurance companies or to the patients. Indeed, the increased cost of medical care has caused the cost of medical insurance to drastically increase over recent years. It has also been recognized that long term hospital stays are not necessary for many procedures. Having much of the recovery period at home may have a positive benefit since the patient may feel more comfortable than in an unfamiliar setting of a hospital.

Accordingly, to save costs and to ensure that the insurance companies pay a larger portion of the cost of surgeries and post-operative care, hospital stays have been drastically reduced and the patient is sent home much sooner for recuperation purposes.

As such, the patient must become aware of and be able to purchase the products that are necessary to complete the recovery process at home.

In addition, when patients leave the hospital after surgery, they are often given written or verbal instructions which generally require additional supplies to aid in their healing process. Typically, the patient has to seek out these additional items at retail stores. Due to the time, complexity, and discomfort involved in gathering these supplies just after leaving the hospital, patients often do not comply with their doctor's orders for recovery. This can result in even greater discomfort for the patient, a slower recover and possible complications.

There exists a company, Home Recovery Catalog of Braselton, Ga. whose website discloses a “Home Recovery Catalog”, which is an on-line and direct mail catalog sales business, specializing in the marketing, sale and delivery of recovery kits which are directed to patients and prospective patients of cosmetic surgical procedures. The kits are stated as being compiled through consultation with “respected physicians and surgeons, nurses and cosmetic patients.”

In addition to the foregoing, the following prior art patent and patent application including the following references:

Monica, U.S. Pat. No. 5,544,753. This patent discloses a back ailments care kit, which includes a dietary supplement compounded to promote healing, and a container for securing an ice pack, analgesic balm, and the dietary supplement. An instruction video 99, a written manual, support pillows, exercise devices and/or other care products may also be included. A patient acquires the kit from a healthcare provider, clinic, retail outlet or the like.

Withers, U.S. Pat. No. 5,752,234. This patent discloses a method and apparatus for providing disposable supplies for health care workers for single visits to patients. The supplies can be tracked through to waste disposal. The system comprises single, trackable, disposable containers which can hold pre-prepared supplies and waste and whose movements can be recorded on a database.

Akasaka et al., U.S. Pat. No. 5,785,650. This patent discloses a medical system for patients at home, which uses computer based units at home for receiving medical data from patients which are linked by a communication channel to computers at a medical center.

Beller et al., U.S. Pat. No. 5,961,446. This patent discloses a system for medical teleconferencing for supplying information on medication scheduling. The system passes information on customized instructions concerning medication, procedures or visits, from a central station to a patient station where the information is stored.

Aruffo et al., U.S. Pat. No. 6,579,271 B1. This patent discloses a self-care system for a post-surgical drain site on, e.g., a cancer patient, which includes a split gauze pad with foam support bar, a drainage record card, a set of step-by-step instructions, and a container for holding system components, among other items.

Franks-Farah et al., U.S. Pat. No. 6,640,976 B1. This patent discloses a patient education system for intermittent male catheterization, include self care documentation for instructing a user, along with male catheters, a lubricant gel tube, antibacterial soap, disposable wipers, and a urine record card.

Franks-Farah et al., US 2004/0055925 A1. This application is a continuation of the application from which the Franks-Farah et al. '976 patent arose, and thus has the same disclosure, and has now issued as U.S. Pat. No. 6,840,379 B2.

Aruffo et al., U.S. Pat. No. 6,740,068 B1. This patent arose from a division of the application from which the Aruffo et al. US '271 patent arose, and thus has the same disclosure.

Landsman et al., US 2004/0167805 A1. This application discloses medical packs which are provided that can include a set number of medications and other medical supplies the amounts of which that are selected for a specific period of home treatment. The medical packs can also include instructions (which may be personalized from the patient's physician) using photographs and a patient log. Return of the pack in a return visit to the treating medical professional can provide a means for evaluating patient compliance.

Aruffo et al., International Apln. PCT/US00/30902, Pub. Doc. WO 01/35299. This reference discloses a medical method for determining the contents of a self care kit, and for conducting in-home medical procedures which identifies the medical procedure to be carried out in a patient's home and further identifies the procedures and materials, and incorporates those materials into a kit.

### SUMMARY OF THE INVENTION

The proposed invention comprises in part, surgical recovery kits, which contain various medical and related articles, which are specifically “tuned” to be used by individuals who are planning to undergo specific medical procedures. The kits are intended to be used by convalescent patients who are recovering at home.

Each kit is composed of a variety of articles (bandages, hot/cold compresses, non-prescription medications, etc.) which, individually and collectively, would be needed or useful to a person recovering from a particular procedure. As many different kits can potentially be assembled as there are procedures, although as a practical matter, many if not most kits will be applicable to more than one procedure. The use of the initials “OTC” herein is an abbreviation of the words “over the counter”.

The kits may have various added-value features, such as personalization (e.g., “This kit has been specially developed for [patient's name] by [health care professional's name]”). The kits will preferably contain highly detailed instructions for their use, and may include information such as contraindications or other warnings useful for a home convalescent. The kits may also contain brochures or promotional literature, separately wrapped promotional items, coupons, questionnaires or surveys which may or may not be specific to the particular surgical procedure or postoperative treatment, etc.

The invention also encompasses a method and process for developing different kits for facilitating post-operative recovery following different medical/surgical procedures, and bringing the knowledge of the availability of those kits to physicians and other health care professionals (as opposed to direct marketing to prospective and actual patients), with various free samples of kits optionally provided to encourage the physicians and health care providers to recommend/prescribe the use of the recovery kits by their patients or home care givers.

The first step is the determination of what surgical procedures are amenable to home convalescence, and thus for home rapid recovery kits, and what articles should be included in such home rapid recovery kits, through conducting of interviews with physicians, therapists and consumers. Once the kits have been presented to the health care professionals, those individuals would serve as the “sales force” to the ultimate customers, the patients.

In a preferred embodiment of the system, the patients would have the kits recommended to them, and be provided with a telephone number or internet site, where the kits can be ordered, with the delivery preferably timed for their receipt just prior to the surgical procedure.

In particular, post-operative home recovery kits that are disclosed herein relate to common types of general surgery; obstetric and gynecological surgery; plastic surgery; orthopedic surgery; otolaryngology surgery. In particular, the following kits relate to the following different kinds of general surgeries: wound care; hemorrhoid; male genital procedures including vasectomy, implant, circumcision (adult and for babies), orchidectomy and prostatectomy.

### BRIEF DESCRIPTION OF THE DRAWINGS

FIG. 1 identifies, in block form, the steps of the method.

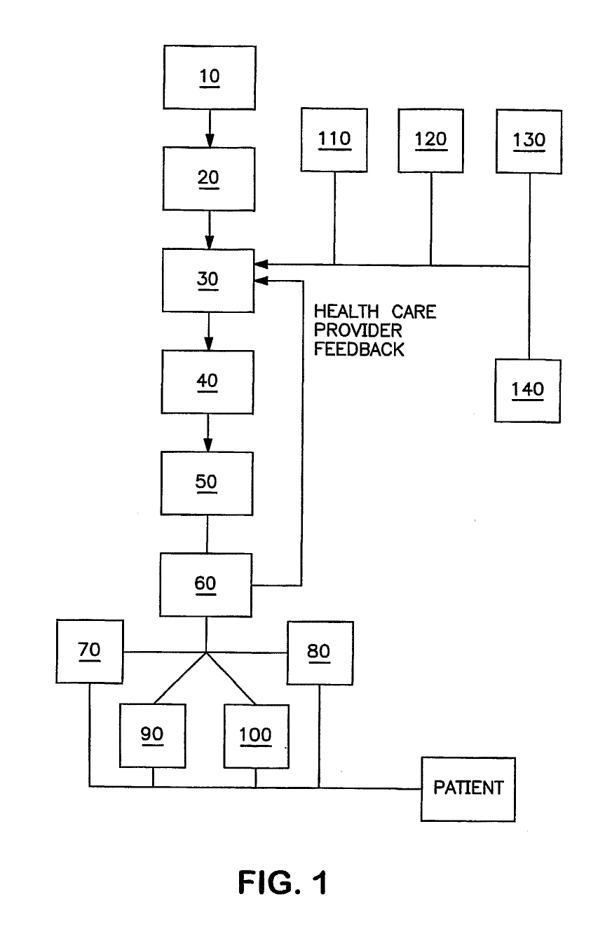

### DETAILED DESCRIPTION OF THE INVENTION

While this invention is susceptible of embodiment in many different forms, there are shown in the drawings and will herein be described in detail, several preferred embodiments of the invention, with the understanding that the present disclosure should be considered as an exemplification of the principles of the invention and is not intended to limit the invention to the embodiments so illustrated.

This application relates to a method of developing and marketing post-operative home recovery kits for use by the patient after discharge from the hospital. In addition, the specification describes a series of home recovery kits for several categories of surgeries as well as specific types of surgeries under each category.

The method comprises identifying the surgery for which the recovery kit will be used (10); consulting with a doctor, therapists, other health care professionals and/or prospective consumers, to determine what articles should be included in the kit (20); developing the necessary and/or optional contents of the recovery kit based upon recommendations from the doctor, therapists, other health care professionals and/or prospective consumers (30); including detailed instructions for the use of the articles that are contained in the recovery kit (40); having the doctor or other health care professional review the contents of the recovery kit prior to distribution (50); and having the kit recommended and possibly distributed by the doctor or health care professional (60). (The recovery kit may be customized for an individual patient).

The method may additionally comprise the step of providing an order by telephone facility to enable the patient to order the kit in advance by phone (70); providing an order by telephone facility to enable a health care provider to order the kit in advance by phone (80); providing an internet based ordering facility to enable the patient to order the kit in advance (90); and/or providing an internet based ordering facility to enable the health care provider to order the kit in advance (100).

The method may additionally comprise the inclusion of free samples of related items within the kit (110); the inclusion of a thank you card to the doctor within the kit (120); the inclusion of special offers and coupons within the kit (130); and the inclusion of a survey or questionnaire (140).

### General Surgery

The following home recovery kits relate to procedures following general surgery including surgeries that require external incisions, hemorrhoid surgery, male genital surgery, circumcision of babies surgery and foot surgery.

Kit 1

This kit relates to recovery procedures following surgeries that require external incisions such as hernia, thyroidectomy, cholecystomy, cardiovascular and lumpectomy surgeries. In particular, the kit covering these procedures includes the following items for the following medical purposes:

| Item | Medical Purpose |
|---|---|
| Scar revision cream | Use after healing to fade incision scars. |
| | Optional. |
| Shower cover | Keep incision area dry when |
| | showering. Optional. |
| Adhesive closure strips | Support incision - helps prevent the |
| | incision from opening. |
| Gauze bandages | Use with paper tape to absorb drainage |
| | and keep incision sterile. |
| Hydrogen peroxide | Use with swabs to remove crust from |
| | the incision. |
| Antibacterial ointment | Apply to incision to prevent crusting |
| | and infection. |
| Paper tape | Use to hold gauze bandage in place. |
| Cotton Swabs | Use with hydrogen peroxide to remove |
| | crust from external incision. |
| Adhesive bandages | Covers incision until completely healed |
| | to prevent infection. |
| Stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Survey/questionnaires | Optional. |

Kit 2

This kit relates to recovery procedures following hemorrhoid surgery. In particular, the kit covering this procedure includes the following items for the following medical purposes:

| Item | Medical Purpose |
|---|---|
| Cooling pack for anal area | Place on anal area to reduce swelling |
| | and discomfort. |
| Bed pads | Prevents pillows and sheet from being |
| | soiled by drainage or medication. |
| | Optional. |
| Sitz bath | Use over toilet to clean anal area. |
| Squirt bottle | Mix water and antiseptic soap in squirt |
| | bottle. Use bottle to squirt the mixture |
| | externally on anus. |
| Antiseptic soap solution | Mix with clean water in squirt bottle. |
| | Use to clean the exterior anal area. |
| Stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Hemorrhoid cream or | Use to control hemorrhoid flare up. |
| Hydrocortisone cream | Also use to externally to control itching |
| | around the anus (not directly on the |
| | incision). |
| Mesh underwear | Use to hold absorbent pad and/or |
| | cooling pack in place. Optional. |
| Topical painkiller | Apply externally to anus as necessary |
| | to reduce pain. Optional. |
| Note pad and pen | Avoid getting up to take a message or |
| | make a note. Optional. |
| Soothing lotion - Witch hazel | Use externally after sitz bath to |
| | moisturize and sooth the area around |
| | the anus. Optional. |
| Antibacterial ointment | Apply to prevent crusting and infection. |
| Absorbent pads | Covers incision area for several days |
| | after the surgery. |
| Survey/questionnaire | Optional. |

Kit 3

This kit relates to recovery procedures following male genital surgery including vasectomy, circumcisions (excluding babies), orchidectomy and prostatectomy surgery. In particular, the kit covering these procedures include the following items for the following medical purposes:

| Item | Medical Purpose |
|---|---|
| Antibacterial ointment | Apply to incision to prevent crusting |
| | and infection. |
| Cotton swabs | Use with hydrogen peroxide to remove |
| | crust from the incision. |
| Gauze bandages | Use with bandages to absorb drainage |
| | and keep incision sterile. |
| Adhesive bandages | Covers incision until completely healed |
| | to prevent infection. |
| Stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Cooling pack for genital area | Place on genital area to reduce swelling |
| | and discomfort. |
| Mesh underwear | Use to hold gauze bandages and/or |
| | cooling pack in place. Optional. |
| Genital support (to be worn | Supports genitals and reduces |
| closely around affected area to | discomfort. Optional. |
| provide support while permitting | |
| limited movement) | |
| Survey/questionnaire | Optional. |

Kit 4

This kit relates to recovery procedures following infant circumcisions. In particular, the kit covering this procedure includes the following items for the following medical purposes:

| Item | Medical Purpose |
|---|---|
| Hydrogen peroxide | Use with swabs to remove crust from |
| | the incision. |
| Antibacterial ointment | Apply to incision to prevent crusting |
| | and infection. |
| Cotton swabs | Use with hydrogen peroxide to remove |
| | crust from the incision. |
| Soothing lotion - Witch hazel | Use externally to moisturize and sooth |
| | the area around the genitals. Optional. |
| Petroleum jelly | Apply to incision area to reduce |
| | irritation from the diaper. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Survey/questionnaire | Optional. |

Kit 5

This kit relates to recovery procedures following foot surgery, such as for in-grown toe nail, tendon or muscle repair, excision of bone and wart removal surgery. In particular, the kit covering these procedures include the following items for the following medical purposes:

| Item | Medical Purpose |
|---|---|
| Cooling pack for foot/toes | Place over foot/toes to reduce swelling |
| | and discomfort. |
| Shower cover | Keep incision area dry when |
| | showering. Optional. |
| Adhesive closure strips | Support incision - helps prevent the |
| | incision from opening. |
| Gauze bandages | Use with paper tape to absorb drainage |
| | and keep incision sterile. |
| Hydrogen peroxide | Use with swabs to remove crust from |
| | the incision. |
| Antibacterial ointment | Apply to incision to prevent crusting |
| | and infection. |
| Paper tape | Use to hold gauze bandage in place. |
| Cotton swabs | Use with hydrogen peroxide to remove |
| | crust from the incision. |
| Adhesive bandages | Covers incision until completely healed |
| | to prevent infection. |
| OTC Stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Foot/toe support (to be worn | Provides support for the foot/toe |
| closely around affected area to | during the healing and rehabilitation |
| provide support while permitting | process. Optional. |
| limited movement) | |
| Foot/toe wedge | Keeps foot/toe above the heart to |
| | minimize swelling and bleeding. |
| | Optional. |
| Surgical shoe | Reduces pressure on the foot from |
| | walking and reduces foot movement. |
| | Optional. |
| Survey/questionnaire | Optional. |

### Obstetric and Gynecological

These home recovery kits relate to recovery procedures following different types of obstetric and gynecological procedures including birth surgery (both vaginal and cesarean); and surgery relating to the uterus, cervix and vagina.

Kit 1

This kit relates to recovery procedures following birth, both vaginal and cesarean, with or without laceration and/or episiotomy. In particular, the kit covering these procedures include the following items for the following medical purposes:

| Item | Medical Purpose |
|---|---|
| Cooling pack for genitals | Place over genitals to reduce swelling |
| | and discomfort. |
| Bed pads | Prevents pillows and sheets from being |
| | soiled by drainage and medication. |
| | Optional. |
| Sitz bath | Use over toilet to clean the external |
| | genital area. |
| Squirt bottle | Mix water and antiseptic soap in squirt |
| | bottle. Use bottle to squirt the mixture |
| | externally on genital area. |
| Antiseptic soap solution | Mix with clean water in squirt bottle. |
| | Use to clean the exterior genital area. |
| Heating pad | Place under back to relax tense |
| | muscles. Optional. |
| Stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Hemorrhoid cream | Use to control hemorrhoid flare up. |
| | Optional. |
| Post partum book | Help mothers understand manage post |
| | partum depression. Optional. |
| Absorbent pads | Use to absorb fluid discharge from the |
| | vagina. |
| Cooling pack for back | Place under back to reduce swelling |
| | and discomfort from strained muscles. |
| Hydrocortisone cream | Use externally to control itching around |
| | the genitals. Optional. |
| Mesh underwear | Use to hold absorbent pads and/or |
| | cooling pack for genitals. Reduces |
| | perspiration and irritation. Optional. |
| Topical painkiller | Apply externally to genitals as |
| | necessary to reduce pain. Optional. |
| Note pad and pen | Avoid getting up to take message or |
| | make a note. Optional. |
| Soothing lotion | Use externally after sitz bath to |
| | moisturize and sooth the area around |
| | the genitals. Optional. |
| In addition, use specifically, | |
| following Cesarean: | |
| Gauze bandages | Use with paper tape to absorb drainage |
| | and keep external incision sterile. |
| Hydrogen peroxide | Use with swabs to remove crust from |
| | the incisions. |
| Antibacterial ointment | Apply to incisions to prevent crusting |
| | and infection. |
| Paper tape | Used to hole gauze bandage in place. |
| Cotton swabs | Use with hydrogen peroxide to remove |
| | crust from the incisions. |
| Adhesive closure strips | Support incision - helps prevent the |
| | incision from opening. |
| Abdominal compression wrap | Maintains pressure on abdomen to |
| | prevent pooling of fluids. Optional. |
| Scar revision cream | Use after healing to fade incision |
| | scars. Optional. |
| Survey/questionnaire | Optional. |

Kit 2

This kit relates to recovery procedures following surgery of the uterus, cervix, vagina, fallopian tubes, and ovaries. In particular, the kit covering these procedures include the following items for the following medical purposes:

| Item | Medical Purpose |
|---|---|
| Cooling pack for genitals | Place over genitals to reduce swelling |
| | and discomfort. |
| Bed pads | Prevents pillows and sheets from being |
| | soiled by drainage or medication. |
| | Optional. |
| Heating pad | Place under back to relax tense |
| | muscles. Optional. |
| Stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Absorbent pads | Use to absorb fluid discharge from the |
| | vagina. |
| Mesh Underwear | Use to hold absorbent pads and/or |
| | cooling pack for genitals. Reduces |
| | perspiration and irritation. Optional. |
| For procedures done through the | |
| abdomen: | |
| Gauze bandages | Use with paper tape to absorb drainage |
| | and keep external incision sterile. |
| Hydrogen peroxide | Use with swabs to remove crust from |
| | the incisions. |
| Antibacterial ointment | Apply to incisions to prevent crusting |
| | and infection. |
| Paper tape | Use to hold gauze bandage in place. |
| Cotton swabs | Use with hydrogen peroxide to remove |
| | crust from the incisions. |
| Adhesive closure strips | Support incision - helps prevent the |
| | incision form opening. |
| Abdominal compression wrap | Maintains pressure on abdomen to |
| | prevent pooling of fluids. Optional. |
| Scar revision cream | Used after healing to fade incision |
| | scars. Optional. |
| Survey/questionnaire | Optional. |

### Plastic Surgery

These kits relate to recovery procedures following different types of plastic surgery including: rhinoplasty (nose) surgery; rhytidectomy (face lift) surgery; abdominoplasty (“tummy tuck”) surgery; blepharoplasty (eyelids) surgery; breast including mastoplexy, mastectomy and breast enlargement surgery; liposuction surgery and face surgery including chemical peel, laser and microderm abrasion.

Kit 1

This kit relates to recovery procedures following rhinoplasty surgery. In particular, the kit covering this procedure includes the following items for the following medical purposes:

| Item | Medical Purpose |
|---|---|
| Elevation wedge | Keeps head (nose) above heart to |
| | minimize swelling and bleeding. |
| | Optional. |
| Antibacterial ointment | Apply to nasal openings and external |
| | incision to prevent crusting and |
| | infection. |
| Bulb syringe | Use to squirt cleansing solution into |
| | nasal passages. |
| Cooling mask for nose and eyes | Place over nose and eyes to reduce |
| | swelling and discomfort. |
| Instructions | |
| Schedule of use | |
| Cotton swabs | Use with hydrogen peroxide to remove |
| | crust from the nostrils and external |
| | incision. |
| Free samples of related medical | Optional. |
| items | |
| Gauze bandage | Use with paper tape to absorb nasal |
| | drainage and keep external incision |
| | sterile. |
| Hydrogen peroxide | Use with swabs to remove crust from |
| | the opening of the nose and external |
| | incision. |
| Lip balm | Apply to lips to prevent drying and |
| | cracking while breathing through the |
| | mouth. Optional. |
| Hypo-allergenic humidifier | Run near bedside to maintain humidity. |
| | This keeps nasal membranes from |
| | drying out and bleeding. Optional. |
| Non-alcohol nasal spray mist | Spray into passages to keep |
| | membranes moist. |
| Nose protector (similar to sports) | Wear to protect the nose and septum |
| | from damage due to an accidental |
| | bump. Optional. |
| Stool softener | Reduces constipation caused by |
| | prescription pain relief. Straining can |
| | rupture healing blood vessels. Optional. |
| Paper tape | Use to hold gauze bandage in place. |
| Cleansing solution | Use cleaning solution in nasal passages |
| | to remove crust, open airway, and |
| | prevent infection. |
| Saline in squirt bottle | Alternative to using cleansing solution. |
| Scar revision cream | Use after healing to fade incision |
| | scars. |
| Shower cover | Keep incision area dry when |
| | showering. Optional. |
| Sun block | Use to prevent scar tissue becoming |
| | sun damaged and more visible. |
| | Optional. |
| Thank you card for the doctor | Optional. |
| Free samples of medical related | Optional. |
| items. | |
| Special offers and coupons for | Optional. |
| medical related items. | |
| Thermometer | Check for fever which could indicate an |
| | infection. Optional. |
| Throat lozenges | Sooths sore throat from surgery and |
| | coats/prevents drying when breathing |
| | through the mouth. Optional. |
| Oral moisturizer | Keeps mouth moist. Optional. |
| Survey/questionnaire | Optional. |

Kit 2

This kit relates to recovery procedures following rhytidectomy (face lift) surgery. In particular, the kit covering this procedure includes the following items for the following medical purposes:

| Item | Medical Purpose |
|---|---|
| Cooling pack for face | Place over face to reduce swelling and |
| | discomfort. |
| Elevation wedge | Keeps head (face) above heart to |
| | minimize swelling and bleeding. |
| | Optional. |
| Gauze bandages | Use with paper tape to absorb drainage |
| | and keep external incision sterile. |
| Hydrogen peroxide | Use with swabs to remove crust from |
| | the incisions. |
| Antibacterial ointment | Apply to incisions to prevent crusting |
| | and infection. |
| Paper tape | Use to hold gauze bandage in place. |
| Scar revision cream | Use after healing to fade incision scars. |
| Cotton swabs | Use with hydrogen peroxide to remove |
| | crust from the incisions. |
| Sun block | Use to prevent scar tissue becoming |
| | sun damaged and more visible. |
| | Optional. |
| Hypo-allergenic Humidifier | Run near bedside to maintain humidity. |
| | This keeps skin from drying out. |
| | Optional. |
| Stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related medical items | |
| Shower cover | Keep incision area dry when |
| | showering. Optional. |
| Hydrocortisone cream | Use on face as necessary to reduce |
| | periodic itching. Optional. |
| Allergy relief medication | Use to control persistent itching. |
| | Optional. |
| Facial band | Holds bandages in place, compresses |
| | tissue and promotes healing, limits |
| | movement. |
| Bed pads | Prevents pillows and sheet from being |
| | soiled by drainage or medication. |
| | Optional. |
| Dry skin soap | Will not dry out the healing areas like |
| | regular soap. Optional. |
| Mild shampoo | Will not irritate the healing areas like |
| | regular shampoo. Optional. |
| Survey/questionnaire | Optional. |

Kit 3

This kit relates to recovery procedures following abdominoplasty (tummy tuck) surgery. In particular, the kit covering this procedure includes the following items for the following medical purposes:

| Item | Medical Purpose |
|---|---|
| Elevation wedge | Keeps body in bent position, reducing |
| | pull on sensitive tummy skin. Optional. |
| Gauze bandage | Use with paper tape to absorb drainage |
| | and keep incisions sterile. |
| Hydrogen peroxide | Use with swabs to remove crust from |
| | the incisions. |
| Antibacterial ointment | Apply to incisions to prevent crusting |
| | and infection. |
| Paper tape | Use to hold gauze bandage in place. |
| Scar revision cream | Use after healing to fade incision scars. |
| Cotton swabs | Use with hydrogen peroxide to remove |
| | crust from the incisions. |
| Stool softener | Reduces constipation caused by |
| | prescription pain relief. Straining can |
| | rupture healing blood vessels. Optional. |
| Thermometer | Check for fever which would indicate |
| | an infection. Optional. |
| Thank you card for the doctor | Optional. |
| Instructions | |
| Schedule of Use | |
| Free samples of related medical | Optional. |
| items | |
| Special offers and coupons for | Optional. |
| related items | |
| Shower cover | Keep incision area dry when |
| | showering. Optional. |
| Hydrocortisone cream | Use on tummy as necessary to reduce |
| | periodic itching. Optional. |
| Allergy relief medication | Use to control persistent itching. |
| | Optional. |
| Dry skin soap | Will not dry out the healing areas like |
| | regular soap. Optional. |
| Knee wedge | Keeps knees bent; reduces pull on |
| | sensitive tummy skin. Optional. |
| Cooling pack for abdomen | Place over tummy to reduce swelling |
| | and discomfort. |
| Abdominal band | Holds bandages in place, compresses |
| | tissue and promotes healing, limits |
| | movement. Optional. |
| Bed pull up device | Use to sit up without putting pressure |
| | on the sensitive tummy skin. Optional. |
| Survey/questionnaire | Optional. |

Kit 4

This kit relates to recovery procedures following blepharoplasty (eyelid) surgery. In particular, the kit covering this procedure includes the following items for the following medical purposes:

| Item | Medical Purpose |
|---|---|
| Elevation wedge | Keeps head (face) above heart to |
| | minimize swelling and bleeding. |
| | Optional. |
| Gauze bandages | Use with paper tape to absorb drainage |
| | and keep incisions sterile. |
| Saline squirt bottle | Use with swabs to remove crust from |
| | the incisions. |
| Ophthalmic Solution | Apply to incisions to lubricate and |
| | prevent crusting and infection. |
| | Optional. |
| Paper tape | Use to hold gauze bandages in place. |
| Scar revision cream | Use after healing to fade incision scars. |
| Cotton swabs | Use with saline to remove crust from |
| | the incisions. |
| Sun block | Use to prevent scar tissue becoming |
| | sun damaged and more visible. |
| | Optional. |
| Stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of medical related | Optional. |
| items | |
| Special offers and coupons for | Optional. |
| related items | |
| Shower goggles | Keep incision area dry when |
| | showering. Optional. |
| Allergy relief medication | Use to control persistent itching. |
| | Optional. |
| Bed pads | Prevents pillows and sheets from being |
| | soiled by drainage or medication. |
| | Optional. |
| Dry skin soap | Will not dry out the healing areas like |
| | regular soap. Optional. |
| Cooling pack for eyes | Place over eyes to reduce swelling and |
| | discomfort. |
| Rewetting eye drops | Use to keep eyes moist during healing |
| | process. Optional. |
| Survey/questionnaire | Optional. |

Kit 5

This kit relates to recovery procedures following breast surgery including mastoplexy, mastectomy and breast enlargement surgery. In particular, the kit covering these procedures include the following items for the following medical purposes:

| Item | Medical Purpose |
|---|---|
| Elevation wedge | Keeps chest above the lower body to |
| | minimize swelling and bleeding. |
| | Optional. |
| Gauze bandage | Use with paper tape to absorb drainage |
| | and keep incisions sterile. |
| Hydrogen peroxide | Use with swabs to remove crust from |
| | the incisions. |
| Antibacterial ointment | Apply to incisions to prevent crusting |
| | and infection. |
| Paper tape | Used to hold gauze bandages in place. |
| Scar revision cream | Use after healing to fade incision |
| | scars. |
| Cotton swabs | Use with hydrogen peroxide to remove |
| | crust from the incisions. |
| Stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Shower cover | Keep incision area dry while showering. |
| | Optional. |
| Hydrocortisone cream | Use on breasts as necessary to reduce |
| | periodic itching. Optional. |
| Allergy relief medication | Use to control persistent itching. |
| | Optional. |
| Bed pads | Prevents pillows and sheets from being |
| | soiled by drainage or medication. |
| | Optional. |
| Dry skin soap | Will not dry out the healing areas like |
| | regular soap. Optional. |
| Cooling pack for breasts | Place over breast to reduce swelling |
| | and discomfort. |
| Breast band | Holds bandages in place, compresses |
| | tissue and promotes healing, limits |
| | movement. Optional. |
| For reduction - full sternum/full | Prevents movement of breasts, |
| back vest | compresses tissue and promotes |
| | healing. Optional. |
| Survey/questionnaire | Optional. |

Kit 6

This kit relates to recovery procedures following liposuction surgery. In particular, the kit covering this procedure includes the following items for the following medical purposes:

| Item | Medical Purpose |
|---|---|
| Gauze bandage | Use with paper tape to absorb draining |
| | and keep incisions sterile. |
| Hydrogen peroxide | Use with swabs to remove crust from |
| | the incisions. |
| Antibacterial ointment | Apply to incisions to prevent crusting |
| | and infection. |
| Paper tape | Use to hold gauze bandages in place. |
| Scar revision cream | Use after healing to fade incision scars. |
| Cotton swabs | Use with hydrogen peroxide to remove |
| | crust from the incisions. |
| OTC stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Shower cover | Keep incision area dry when |
| | showering. Optional. |
| Hydrocortisone cream | Use on skin necessary to reduce |
| | periodic itching. Optional. |
| Allergy relief medication | Use to control persistent itching. |
| | Optional. |
| Bed pads | Prevents pillows and sheets from being |
| | soiled by draining or medication. |
| | Optional. |
| Dry skin soap | Will not dry out the healing areas like |
| | regular soap. Optional. |
| Cooling pack | Place over affected area to reduce |
| | swelling and discomfort. |
| Compression wraps | Holds bandages in place, compresses |
| | tissue and promotes healing, limits |
| | movement. Optional. |
| Undergarment pads | Protects clothing from being soiled by |
| | drainage or medicine. Optional. |
| Survey/questionnaire | Optional. |

Kit 7

This kit relates to recovery procedures following facial surgery including chemical peel, laser surgery and microderm abrasion. In particular, the kit covering these procedures include the following items for the following medical purposes:

| Item | Medical Purpose |
|---|---|
| Cooling pack for face | Place over face to reduce swelling and |
| | discomfort. |
| Elevation wedge | Keeps head (face) above heart to |
| | minimize swelling and bleeding. |
| | Optional. |
| Gauze bandage | Use to soak off any crust or scabs. |
| Scar revision cream | Use after healing to fade scars. |
| Sun block | Use to prevent scar tissue from |
| | becoming sun damaged and more |
| | visible. Optional. |
| Stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions - laminated | |
| Schedule of use | |
| Free samples of related medical | Optional. |
| items | |
| Special offers and coupons for | Optional. |
| related items | |
| Shower cover | Keep affected area dry when |
| | showering. Optional. |
| Hydrocortisone cream | Use on face as necessary to reduce |
| | periodic itching. Optional. |
| Allergy relief medication | Use to control persistent itching. |
| | Optional. |
| Bed pads | Prevents pillow and sheets from being |
| | soiled by draining or medication. |
| | Optional. |
| Dry skin soap | Will not dry out the healing area like |
| | regular soap. Optional. |
| Mild shampoo | Will not irritate the healing area like |
| | regular shampoo. Optional. |
| Head/Hair band | Keeps hair out of face while healing. |
| | Optional. |
| Cotton balls | Used to gently clean affected areas. |
| Soothing solution | Use with face compress to sooth face |
| | and reduce irritation. |
| Face compress | Use with soothing solution to sooth |
| | face and reduce irritation. |
| Moisturizing cream | Rehydrates and protects sensitive skin. |
| | Optional. |
| Eye drops | Relieves eye irritation brought on by |
| | the procedure or healing process. |
| | Optional. |
| Survey/questionnaire | Optional. |

### Orthopedic Procedures

The following home care kits relate to recovery procedures following different types of orthopedic surgeries, including knee (both arthroscopy and cartilage); shoulder (both arthroscopy, and rotator cuff); and elbow (including tendons, excision of bone and bursa).

Kit 1

This kit relates to recovery procedures for knee surgeries primarily arthroscopy, cartilage and meniscus surgery. In particular, the kit covering these procedures include the following items for the following medical purposes:

| Item | Medical Purpose |
|---|---|
| Knee wedge | Keeps knee above heart to minimize |
| | swelling and bleeding. Optional. |
| Cooling pack for knee | Place over knee to reduce swelling and |
| | discomfort. |
| Compression stockings | Reduce swelling and enhance |
| | circulation. Optional. |
| Shower cover | Keep incision area dry when |
| | showering. Optional. |
| Knee support (to be worn | Provides support for the knee during |
| closely around affected area to | the healing and rehabilitation process. |
| provide support while permitting | Optional. |
| limited movement) | |
| Adhesive closure strips | Support incision - helps prevent the |
| | incision from opening. |
| Gauze bandages | Use with paper tape to absorb drainage |
| | and keep incision sterile. |
| Hydrogen peroxide | Use with swabs to remove crust from |
| | the incision. |
| Antibacterial ointment | Apply to incision to prevent crusting |
| | and infection. |
| Paper tape | Use to hold gauze bandages in place |
| Cotton swabs | Use with hydrogen peroxide to remove |
| | crust from the external incision. |
| Adhesive bandages | Covers incision until completely healed |
| | to prevent infection. |
| Stool softener | Reduces constipation caused by |
| | prescription pain relief. Straining can |
| | rupture healing blood vessels. Optional. |
| Thermometer | Check for fever which could indicate |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Survey/questionnaire | Optional. |

Kit 2

This kit relates to recovery procedures following shoulder surgery including arthroscopy and rotator cuff surgery. In particular, the kit covering these procedures include the following items for the following medical purposes:

| Item | Medical Purpose |
|---|---|
| Elevation wedge | Keeps shoulder above heart to |
| | minimize swelling and bleeding. |
| | Optional. |
| Cooling pack for shoulder | Place over shoulder to reduce swelling |
| | and discomfort. |
| Shower cover | Keep incision area dry when |
| | showering. Optional. |
| Adhesive closure strips | Support incision - helps prevent the |
| | incision from opening. |
| Gauze bandages | Use with paper tape to absorb drainage |
| | and keep incision sterile. |
| Hydrogen peroxide | Use with swabs to remove crust from |
| | the incision. |
| Antibacterial ointment | Apply to incision to prevent crusting |
| | and infection. |
| Paper tape | Use to hold gauze bandage in place. |
| Cotton swabs | Use with hydrogen peroxide to remove |
| | crust from the incision. |
| Adhesive bandages | Covers incision until completely healed |
| | to prevent infection. |
| Stool softener | Reduces constipation from prescription |
| | pain relief. Straining can rupture |
| | healing blood vessels. Optional. |
| Thermometer | Check for fever which could indicate |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Sling | Immobilizes arm/shoulder during the |
| | healing process. Optional. |
| Shoulder support (to be worn | Provides support for the shoulder |
| closely around affected area to | during healing and rehabilitation |
| provide support while permitting | process. Optional. |
| limited movement) | |
| Survey/questionnaire | Optional. |

Kit 3

This kit relates to recovery procedures following elbow surgery involving tendons, excision of bone and bursa surgery. In particular, the kit covering these procedures include the following items for the following medical purposes:

| Item | Medical Purpose |
|---|---|
| Cooling pack for elbow | Place over elbow to reduce swelling |
| | and discomfort. |
| Shower cover | Keep incision area dry when |
| | showering. Optional. |
| Adhesive closure strips | Support incision - helps prevent the |
| | incision from opening. |
| Gauze bandages | Use with paper tape to absorb drainage |
| | and keep incision sterile. |
| Hydrogen peroxide | Use with swabs to remove crust from |
| | the incision. |
| Antibacterial ointment | Apply to incision to prevent crusting |
| | and infection. |
| Paper tape | Use to hold gauze bandage in place. |
| Cotton swabs | Use with hydrogen peroxide to remove |
| | crust from the incision. |
| Adhesive bandages | Covers incision until completely healed |
| | to prevent infection. |
| OTC stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Sling | Immobilizes arm/elbow during the |
| | healing process. Optional. |
| Elbow support (to be worn | Provides support for the elbow during |
| closely around affected area to | the healing and rehabilitation process. |
| provide support while permitting | Optional. |
| limited movement) | |
| Elbow pad | Provides comfort when elbow is resting |
| | on things. Optional. |
| Elbow wedge | Keeps elbow above heart to minimize |
| | swelling and bleeding. Optional. |
| Survey/questionnaire | Optional. |

Kit 4

This kit relates to recovery procedures following hand and wrist surgery including carpal tunnel and tendon surgery. In particular, the kit covering these procedures include the following items for the following medical purposes:

| Item | Medical Purpose |
|---|---|
| Cooling pack for hand/wrist | Place over hand/wrist to reduce |
| | swelling and discomfort. |
| Shower cover | Keep incision area dry when |
| | showering. Optional. |
| Adhesive closure strips | Support incision - helps prevent the |
| | incision from opening. |
| Gauze bandages | Use with paper tape to absorb drainage |
| | and keep incision sterile. |
| Hydrogen peroxide | Use with swabs to remove crust from |
| | the incision. |
| Antibacterial ointment | Apply to incision to prevent crusting |
| | and infection. |
| Paper tape | Use to hold gauze bandage in place. |
| Cotton swabs | Use with hydrogen peroxide to remove |
| | crust from the incision. |
| Adhesive bandages | Covers incision until completely healed |
| | to prevent infection. |
| OTC stool softener | Reduces constipation caused by |
| | prescription pain relief. Straining can |
| | rupture healing blood vessels. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Sling | Immobilizes hand/wrist during the |
| | healing process. Optional. |
| Hand/wrist support (to be worn | Provides support for the hand/wrist |
| closely around affected area to | during the healing and rehabilitation |
| provide support while permitting | process. Optional. |
| limited movement) | |
| Hand/wrist wedge | Keeps hand/wrist above heart to |
| | minimize swelling and bleeding. |
| | Optional. |
| Hand exerciser | Use to strengthen hand during the |
| | rehabilitation process. Optional. |
| Survey/questionnaire | Optional. |

Kit 5

This kit relates to recovery procedures following back and spine surgery including stenosis, fusions and discectomy surgery. In particular, the kit covering these procedures include the following items for the following medical purposes:

| Item | Medical Purpose |
|---|---|
| Cooling pack for back | Place over incision area on back to |
| | reduce swelling and discomfort. |
| Shower cover | Keep incision area dry when |
| | showering. Optional. |
| Adhesive closure strips | Support incision - helps prevent the |
| | incision from opening. |
| Gauze bandages | Use with paper tape to absorb drainage |
| | and keep incision sterile. |
| Hydrogen peroxide | Use with swab to remove crust from |
| | the incision. |
| Antibacterial ointment | Apply to incision to prevent crusting |
| | and infection. |
| Paper tape | Use to hold gauze bandage in place. |
| Cotton swabs | Use with hydrogen peroxide to remove |
| | crust from the incision. |
| Adhesive bandages | Covers incision until completely healed |
| | to prevent infection. |
| OTC stool softener | Reduces constipation caused by |
| | prescription pain relief. Straining can |
| | rupture healing blood vessels. Optional. |
| Thermometer | Check for fever which could indicate |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Bed pull up device | Use to sit up without pressure on the |
| | back. Optional. |
| Heating pad | Alternate with cool pack to reduce |
| | discomfort and increase flexibility (after |
| | 72 hours). Optional. |
| Back supporter | Provides support for the back during |
| | the healing and rehabilitation process. |
| | Optional. |
| Back wedge | Keeps back above legs to minimize |
| | swelling and bleeding. Optional. |
| Survey/questionnaire | Optional. |

### Otolaryngology Procedures

The following home kits relates to recovery procedures following different types of otolaryngology surgery including nasal and sinus (septoplasty and ethmoidectomy) throat (tonsillectomy and adenoidectomy) surgery; and otologic (stapedectomy and choleseatoma) surgery.

### Kit 1

This kit relates recovery procedures following nasal and sinus (septoplasty and ethmoidectomy) surgery. In particular, the kit covering these procedures include the following items for the following medical purposes:

| Item | Medical Purpose |
|---|---|
| Elevation wedge | Keeps head (nose) above heart to |
| | minimize swelling and bleeding. |
| | Optional. |
| Antibiotic ointment | Apply to nasal openings to minimize |
| | crusting of drainage. |
| Bulb syringe | Squirt cleansing solution into nasal |
| | passage to remove crusting, open |
| | airway, and reduce likelihood of |
| | infection. |
| Cotton swabs | Use with hydrogen peroxide to remove |
| | crust from opening of the nose. |
| Cooling pack for eyes and nose | Place over nose and eyes to reduce |
| | swelling and discomfort. |
| Hydrogen peroxide | Use with swabs to remove crust from |
| | the opening of the nose. |
| Lip balm | Apply to lips to prevent drying and |
| | cracking while breathing through the |
| | mouth. Optional. |
| Hypo-allergenic Humidifier | Run near bedside to maintain humidity. |
| | This keeps membranes in the nasal |
| | passages from drying out and bleeding. |
| | Optional. |
| Oral moisturizer | Apply on tongue and in mouth to |
| | prevent drying and cracking while |
| | breathing through the mouth. Optional. |
| Nasal bandages | Use with paper tape to absorb drainage |
| | from the nostrils. |
| Non-alcohol nasal spray mist | Spray into nasal passages to keep |
| | membranes moist |
| Nose protector | Wear over nose to protect the nose |
| | and septum to avoid damages from an |
| | accidental bump. Optional. |
| Nasal decongestant | Use to control persistent bleeding - |
| | consult physician before use. |
| Stool softener | Reduces constipation caused by |
| | prescription pain relief. Straining can |
| | rupture healing blood vessels. Optional. |
| Paper tape | Use to hold nasal bandage in place. |
| Cleansing solution | Use cleansing solution in nasal passage |
| | to remove crusting, open airway, and |
| | reduce likelihood of infection. |
| Saline in squirt bottle | Alternative to using cleansing solution. |
| Throat lozenges | Sooths sore throat resulting from |
| | surgery and coats throat/prevents |
| | drying when breathing through the |
| | mouth. Optional. |
| Thermometer | Check for fever which could indicate an |
| | infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Surveys/questionnaire | Optional. |

Kit 2

This kit relates to recovery procedures following throat (tonsillectomy and adenoidectomy) surgery. In particular, the kit covering these procedures include the following items for the following medical purposes:

| Item | Medical Purpose |
|---|---|
| Lip balm | Apply to lips to prevent drying and |
| | cracking. Optional. |
| Stool softener | Reduces constipation caused by |
| | prescription pain relief. Straining can |
| | rupture blood vessels in the nasal |
| | passages. Optional. |
| Thermometer | Check for fever which could indicate an |
| | infection. |
| Thank you card for the doctor | Optional. |
| Instructions | |
| Schedule of use | |
| Free samples of related medical | Optional. |
| items | |
| Special offers and coupons for | Optional. |
| related items | |
| Cooling pack for neck and ears | Place over neck and ears to reduce |
| | swelling and discomfort. |
| Rehydrating freezer pops | Replenishes electrolytes, sooths throat, |
| | reduces swelling. Optional. |
| Water bottle with squirt top | Use bedside for water or thirst |
| | quencher. Optional. |
| Powdered thirst quencher | Mix with water and keep bedside. Keep |
| | mouth and throat moist, and body fully |
| | hydrated. Optional. |
| Anesthetic throat spray | Spray topical antiseptic on back of |
| | throat to reduce pain. |
| Salt packs | Mix with water and gargle to clean |
| | surgical site and reduce risk of infection |
| Elevation wedge | Keeps head/throat above heart to |
| | minimize swelling and bleeding. |
| | Optional. |
| Survey/questionnaire | Optional. |

Kit 3

This kit relates to recovery procedures following otologic (stapedectomy and cholesteatoma) surgery. In particular, the kit covering these procedures include the following items for the following medical purposes:

| Item | Medical Purpose |
|---|---|
| Elevation wedge | Keeps head (ears) above heart to |
| | minimize swelling and bleeding. |
| | Optional. |
| Antibiotic ointment | Use on exterior incisions to prevent |
| | infection. |
| Cotton swabs | Use with hydrogen peroxide to remove |
| | crust from the incision area and |
| | prevent infection. |
| Hydrogen peroxide | Use with swabs to remove crust from |
| | the incision area and prevent infection. |
| Bandages | Maintain sterile coverage of incision |
| | site and/or ear. |
| Stool softener | Reduces constipation caused by |
| | prescription pain relief. Straining can |
| | rupture blood vessels. Optional. |
| Paper tape | Use to hold gauze bandage in place. |
| Thermometer | Check for fever which could indicate |
| | and infection. Optional. |
| Thank you card for the doctor | Optional. |
| Instructions | |
| Schedule of use | |
| Free samples of related medical | Optional. |
| items | |
| Special offers and coupons for | Optional. |
| related items | |
| Head band | Use to hold gauze bandage in place |
| | and keep ears from moving. |
| Cooling pack for ears | Place over neck and ears to reduce |
| | swelling and discomfort. |
| Shower cap | Keep incision area dry and water out of |
| | ears when showering. Optional. |
| Ear plugs | Use to keep water out of ears when |
| | swimming. Optional. |
| Survey/questionnaire | Optional. |

### Skin Repair Kit

This kit relates to recovery procedures following dermatological surgery such as tumor, keloid and mole removal; laceration repair and scar revision. In particular, the kit covering these procedures include the following items for the following medical purposes:

| Item | Medical Purpose |
|---|---|
| Scar revision cream | Use after healing to fade incision |
| | scars. |
| Shower cover | Keep incision area dry when |
| | showering. Optional. |
| Adhesive closure strips | Support incision - helps prevent the |
| | incision from opening. |
| Gauze bandages | Use with paper tape to absorb drainage |
| | and keep incision sterile. |
| Hydrogen peroxide | Use with swabs to remove crust from |
| | the incision. |
| Antibacterial ointment | Apply to incision to prevent crusting |
| | and infection. |
| Paper tape | Use to hold gauze bandage in place. |
| Cotton swabs | Use with hydrogen peroxide to remove |
| | crust from the external incision. |
| Adhesive bandages | Covers incision until completely healed |
| | to prevent infection. |
| Thermometer | Check for fever which could indicate |
| | and infection. Optional. |
| Thank you card for the doctor | Optional. |
| Instructions | |
| Schedule of use | |
| Free Samples of Related | Optional. |
| Medical Items | |
| Special Offers and Coupons for | Optional. |
| Related Items | |
| Survey/questionnaire | Optional. |

### Dentistry & Oral Surgery

This kit relates to recovery procedures following surgery for tooth extraction including the removal of wisdom teeth (impacted or not) and other bases for the removal of teeth. In particular, the kit covering these procedures include the following items for the following medical purposes:

| Item | Medical Purpose |
|---|---|
| Elevation wedge | Keeps head (throat) above heart to |
| | minimize swelling and bleeding. |
| | Optional. |
| Stool softener | Reduces constipation caused by |
| | prescription pain relief. Straining can |
| | rupture blood vessels. Optional. |
| Thermometer | Check for fever which could indicate an |
| | infection. Optional. |
| Thank you card for your doctor | Optional. |
| Instructions | |
| Schedule of use | |
| Free samples of related medical | Optional. |
| items | |
| Special offers and coupons for | Optional. |
| related items | |
| Cooling pack for cheeks, neck | Place over cheeks, neck and ears to |
| and ears | reduce swelling and discomfort. |
| Topical painkiller | Spray topical painkiller on affected area |
| | to reduce pain. |
| Salt packets | Mix with water and gargle to clean the |
| | surgical site and reduce risk of |
| | infection. |
| Gauze bandages | Use to pack extraction site. Optional. |

The foregoing description and drawings merely explain and illustrate the invention, and the invention is not limited thereto, except as those skilled in the art who have the present disclosure before them will be able to make modifications and variations therein without departing from the scope of the invention.

What is claimed is:

1. A method for developing and marketing a post operative home recovery kit for use by a patient after discharge from a hospital and for recuperation at home comprising the following steps:
(a) identifying the surgery for which the recovery kit is to be used;
(b) consulting with a doctor, therapists, other health care professionals, and/or prospective consumers to determine what articles should be contained in the recovery kit;
(c) developing the necessary and/or optional contents of the recovery kit based upon the recommendations by the doctor, therapists, other health care professionals and/or prospective consumers;
(d) including detailed instructions regarding the use of the articles that are contained within recovery kit;
(e) having the doctor or other health care professional review the content of the recovery kit prior to its initial distribution; and
(f) having the kit recommended by the physician or other health care provider.

2. The method of claim 1 further comprising the step of providing an order by telephone facility to enable the patient to order the kit in advance by phone.

3. The method of claim 1 further comprising the step of providing an order by telephone facility to enable the health care provider to order the kit in advance by phone.

4. The method of claim 1 further comprising the step of providing an internet based ordering facility to enable the patient to order the kit in advance.

5. The method of claim 1 further comprising the step of providing an internet based ordering facility to enable the health care provider to order the kit in advance.

6. The method of claim 1 further comprising the inclusion of free samples of related items within the kit.

7. The method of claim 1 further comprising the inclusion of a thank you card to the doctor within the kit.

8. The method of claim 1 further comprising the inclusion of special offers coupons within the kit.

9. The method of claim 1 further comprising the inclusion of surveys and or questionnaires within the kit.

10. (canceled)

11. A post procedure home recovery kit for use in connection with obstetric and gynecological surgery, and, in particular, birth home recovery kits, particularly for recover from caesarian surgeries, the contents of said home recovery kit comprising: a cooling pack for genitals; sitz bath; squirt bottle; antiseptic soap solution; instructions; schedule of use; absorbent pads; cooling pack for back; gauze bandages; hydrogen peroxide; antibacterial ointment; paper tape; cotton swabs; adhesive closure strips.

12. (canceled)

13. A post procedure home recovery kit for use in connection with obstetric and gynecological surgery, and, in particular, surgery related to the uterus, cervix, vagina, fallopian tubes and ovaries, particularly for procedures done through the abdomen, the contents of said home recovery kit comprising: a cooling pack for the genitals; thermometer; instructions; schedule of use; absorbent pads; gauze bandages; hydrogen peroxide; antibacterial ointment; paper tape; cotton swabs; adhesive closure strips.

14. (canceled)

15. A post procedure recovery kit for use in connection with general surgery, and, in particular, hemorrhoid surgery, the contents of said recovery kit comprising: a cooling pack for anus; sitz bath; squirt bottle; antiseptic soap solution; instructions; schedule of use; hemorrhoid cream and/or hydrocortisone cream; antibacterial ointment; absorbent pads.

16-29. (canceled)
